(19) United States
(12) Patent Application Publication
(10) Pub. No.: US 2009/0256665 A1
(43) Pub. Date: Oct. 15, 2009

(54) VIBRATION-PROOF HOLDER APPLICABLE TO COMMUNICATION/NAVIGATION DEVICES FOR VEHICLE USE

(75) Inventor: Yu-Chi Cheng, Taoyuan (TW)

Correspondence Address: LAW OFFICES OF MIKIO ISHIMARU, 333 W. EL CAMINO REAL, SUITE 330, SUNNYVALE, CA, 94087, US

(73) Assignee: MITAC INTERNATIONAL CORPORATION, Taoyuan (TW)

(21) Appl. No.: 12/420,819

(22) Filed: Apr. 8, 2009

(30) Foreign Application Priority Data
Apr. 9, 2008 (TW) 097112793

(51) Int. Cl. H01F 7/20

(52) U.S. Cl. 335/290

(57) ABSTRACT

A vibration-proof holder applicable to a communications/navigation device for vehicle use is provided, characterized by the use of a gap-detecting unit to detect position variations of the communications/navigation device, and an electromagnetic control unit to adjust magnetic intensity of magnetic bodies fixedly installed in the vehicle, wherein first and second magnetic bodies are limited to remain in the same track and to face one another with the same magnetic polar end thereof, such that the communications/navigation device can return to its initial position to achieve the vibration-proof effect.

### BACKGROUND OF THE INVENTION

1. Field of the Invention

The present invention generally relates to a vibration-proof holders applicable to electronic communications and/or navigation devices, and more particularly, to a vibration-proof holder applicable to electronics devices for use in vehicles.

2. Description of the Related Art

The integration of satellite navigation (GPS) devices with communications devices such as cell phones is increasingly popular, especially for portable navigation products. Navigation devices are widely used in automobile vehicles nowadays and such navigation devices are typically held in place by a conventional fastening mechanism such as that depicted in FIG. 1. As illustrated, the navigation device 1 for use in vehicles is held by a support mount that includes a complementary foot rack 2 configured to hold the navigation device 1 in place by coupling the navigation device 1 to a fixed base 20 on an end of the foot rack 2. The fixed base 20 is connected to a stand 21 via the foot rack 2 that may be pivoted in order to adjust the position of the navigation device 1. Further, a suction cup 22 is provided at the other end of the stand 21 to be attached to a smooth surface of the vehicle, such as the windshield, for securing the navigation device 1 and support mount thereto.

The conventional foot rack 2 as described above is known to have some disadvantages in practical usage. Specifically, the foot rack is susceptible to vibrations when driving the vehicle over uneven surfaces and on rough/bumpy roads, adversely affecting the function of the navigation device 1 and even causing damage thereto due to severe vibration or contact between the navigation device 1 and objects or surfaces. Moreover, it is doubtful as to whether it is safe to attach the navigation device 1 to the windshield glass by means of the suction cup. Therefore, it is desirable and beneficial to provide a novel vibration-proof holder applicable to communications/navigation devices for use in vehicles that can improve on the drawbacks of prior techniques.

### SUMMARY OF THE INVENTION

In view of the drawbacks associated with the prior art, the invention provides a vibration-proof holder applicable to a communications/navigation device for vehicle use, the vibration-proof holder being connected to the communications/navigation device and a vehicle and comprising: a power supply unit for outputting an adjustable electric current; a first magnetic body and a second magnetic body fixedly installed in the communications/navigation device and the vehicle respectively, at least one of first and second magnetic bodies being an electrical magnetic body and electrically connected to the power supply unit; a limiting member fixedly installed in the vehicle to restrict the first and second magnetic bodies in the same track, the first and second magnetic bodies facing one another with at least one same magnetic pole thereof; a gap-detecting unit configured to detect a gap value between the first and second magnetic bodies and to further output a magnetic force adjusting signal if the detected gap value deviates from a preset value; and an electromagnetic control unit configured to receive the magnetic force adjusting signal output from the gap-detecting unit and to control the magnetic intensity of the first magnetic body and/or the second magnetic body by adjusting the adjustable electric current output from the power supply unit according to the detected gap value, thereby adjusting the gap value therebetween to match the preset value.

In a preferred embodiment, the first magnetic body is an electromagnet, and the second magnetic body is a permanent magnet, or vice versa, and thus the positions of the two kinds of magnets can be reversed. Alternatively, first and second magnetic bodies are constituted by the permanent magnet and the electromagnet combined with one another, and the first and second magnetic bodies are disposed in a stacked vertical orientation. The cross-sections of the first and second magnetic bodies are of an “M” shape. The gap-detecting unit is a gap sensor, and the communications/navigation device is a satellite navigation device.

The present invention further provides a vibration-proof holder applicable to a communications/navigation device for vehicle use, the vibration-proof holder being connected to the communications/navigation device and a vehicle and comprising: a power supply unit for outputting an adjustable electric current; a first magnetic body and a plurality of second magnetic bodies fixedly installed in the communications/navigation device and the vehicle respectively, at least one of the first and second magnetic bodies being an electromagnet and electrically connected to the power supply unit; a limiting member fixedly installed in the vehicle to restrict first and second magnetic bodies in the same track, the first and second magnetic bodies facing one another with at least one same magnetic pole thereof; a gap-detecting unit configured to detect a gap value between the first and second magnetic bodies and to further output a magnetic force adjusting signal if the detected gap value deviates from a preset value; and an electromagnetic control unit configured to receive the magnetic force adjusting signal output from the gap-detecting unit and to control the magnetic intensity of the first magnetic body and/or second magnetic bodies by adjusting the adjustable electric current output from the power supply unit according to the detected gap value, thereby adjusting the gap value therebetween to be consistent with the preset value.

In a preferred embodiment, the first magnetic body is an electromagnet, and each of second magnetic bodies is a permanent magnet, or vice versa, and thus the position of the two types of magnets can be reversed. Alternatively, the first magnetic body and second magnetic bodies are constituted by the permanent magnet and the electromagnet combined with one another. The first magnetic body and second magnetic bodies are all disposed in a horizontal direction. The first magnetic body and second magnetic bodies are of a rectangular shape. The gap-detecting unit is a gap sensor, and the communications/navigation device is a satellite navigation device.

In summary, the vibration-proof holder applicable to a communications/ navigation device for vehicle use of the present invention is characterized by the provision of a gap-detecting unit for detecting position variations of the communications/navigation device; an electromagnetic control unit configured to adjust the magnetic intensity of the first magnetic body fixedly installed in the communications/navigation device or the second magnetic body disposed in the vehicle body; and a limiting member configured to control and restrict the first and second magnetic bodies to remain in the same track and to face one another with one same magnetic pole thereof, thereby enabling the communications/navigation device to return to its original set position for the purpose of vibration-proofing the device against progressive movement. Furthermore, the vibration-proof holder of the present invention has a simple structure and can be produced at low costs and thus has high applicability.

### BRIEF DESCRIPTION OF THE DRAWINGS

The present invention can be more fully understood by reading the following detailed description of the preferred embodiments, with reference made to the accompanying drawings, wherein:

FIG. 1 is a schematic perspective diagram showing a foot rack applicable to a conventional satellite navigation device;

FIG. 2 is a schematic structural diagram showing a first embodiment of the vibration-proof holder applicable to a communications/navigation device of a vehicle in accordance with a first preferred embodiment of the present invention;

FIGS. 3A and 3B are schematic application diagrams showing the vibration-proof holder applicable to a communications/navigation device of a vehicle in accordance with the first preferred embodiment of the present invention; and

FIGS. 4A and 4B are schematic perspective diagrams showing two application examples of the vibration-proof holder applicable to a communications/navigation device of a vehicle in accordance with a second preferred embodiment of the present invention.

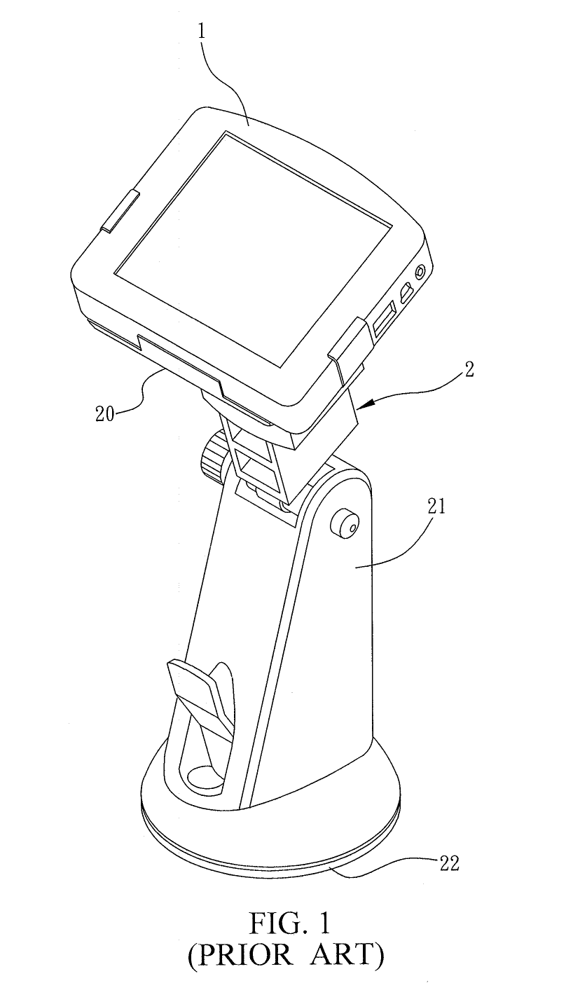

### DETAILED DESCRIPTION OF THE PREFERRED EMBODIMENTS

The following illustrative embodiments are provided to illustrate the disclosure of the present invention. These and other advantages and effects can be readily understood by persons skilled in the art after reading the disclosure of this specification. The present invention can also be performed or applied by other differing embodiments. The details of the specification may be changed on the basis of different points and applications, and numerous modifications and variations can be devised without departing from the spirit of the present invention.

### The First Embodiment

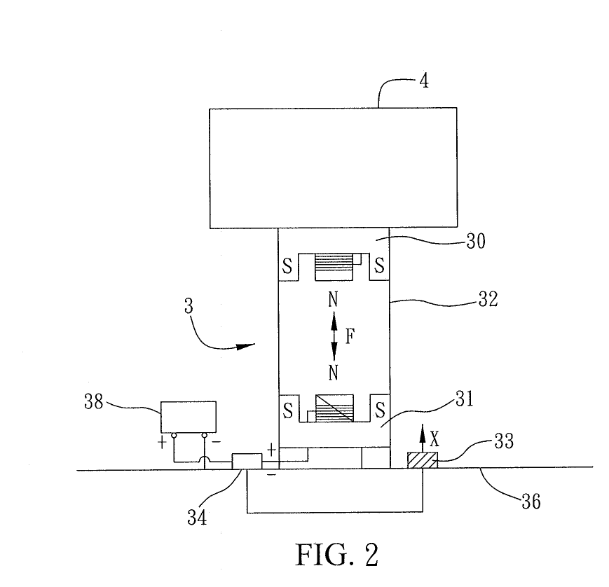

FIG. 2 depicts a vibration-proof device 3 (hereinafter referred to as vibration-proof holder 3) applicable to a communications and/or navigation device of a vehicle in accordance with a first embodiment of the present invention. In this embodiment, the communications and/or navigation device 4 (hereinafter referred to as communications/navigation device 4) applicable for a vehicle refers to a satellite navigation device for vehicular usage. Note that the communications/navigation device 4 may be other portable electronic device such as mobile phone and Personal Digital Assistant (PDA) and is not limited to that disclosed in this embodiment. The vibration-proof holder 3 is applicable for vehicle use, and more specifically, is to be installed in a vehicle body 36 such as a car body. In other embodiments of the present invention, the vibration-proof holder 3 may be applicable for use with boats, aircraft, etc.

The vibration-proof holder 3 is comprised of: a first magnetic body 30 installed in the communications/navigation device 4, a second magnetic body 31 installed in the vehicle body 36, a limiting member 32, a gap-detecting unit 33, and an electromagnetic control unit 34. Preferably, the first magnetic body 30 is detachably installed in the communications/navigation device 4, and the second magnetic body 31, the limiting member 32, the gap-detecting unit 33, and the electromagnetic control unit 34 are installed in/on an interior surface of the vehicle body 36. Moreover, preferably, the second magnetic body 31, the limiting member 32, the gap-detecting unit 33, and the electromagnetic control unit 34 are detachably installed in/on the interior surface of the vehicle body 36. The vehicle body 36 may be, for example, an awning, a dash panel or a window.

In this embodiment, at least one of first and second magnetic bodies 30, 31 is an electromagnet and the other is a permanent magnet, the electromagnet being electrically connecting with a power supply unit 38 for outputting an adjustable electric current therefrom. Besides, the limiting member 32 is such as a track to restrict the first and second magnetic bodies 30, 31 in the same track, and the first and second magnetic bodies 30, 31 are disposed to face each other with the same magnetic pole thereof More specifically, the first magnetic body 30 installed in the communications/navigation device 4 has a slide part (not shown) to allow the slide of the first magnetic body 30 on the track (the limiting member 32) after being attached to the limiting member 32.

As can be seen from the drawing, the cross-sections of first and second magnetic bodies 30, 31 are of an “M” shape, and the first and second magnetic bodies 30, 31 are disposed in a vertical orientation and face one another with at least one same polar end thereof; in other words, either the north pole faces the north pole, or the south pole faces the south pole, or both, thereby generating a repulsive force F between first and second magnetic bodies 30, 31 to sustain and hold the communications/navigation device 4 in place.

Preferably, the first and second magnetic bodies 30, 31 are constituted by the permanent magnet and the electromagnet combined with one another, such that the fixed permanent magnets remain vibration-proof function even if first and second magnetic bodies 30, 31 are not electrified, thereby saving power and costs.

According to the needs of the situation, the first and second magnetic bodies 30, 31 may be electrified when subjected to and under persistently strong vibrations. Compared to the permanent magnet, the magnetic capability of an electromagnet is stronger and adjustable by adjusting electric currents. In practical usage, the first magnetic body 30 may be an electromagnet, and the second magnetic body 31 is a permanent magnet, or vice versa, and thus the positions of the two types of magnets can be reversed.

Further, the first magnetic body 30 may be fastened to the communications/navigation device 4 by the stabilizing base of the prior art. The limiting member 32 comprises, but is not limited to, sliding track or path that is to be coupled to first and second magnetic bodies 30, 31 to thereby restrict magnetic bodies 30, 31 to remain in the same track without deviating from one another. The limiting member 32 may further comprise a fixed base (not shown) that is fixed on the vehicle body 36, thereby forming an integrated fixing rack of the communications/navigation device 4. Note that the base mentioned above is optional and the existing fastening rack may be used in conjunction with the vibration-proof holder 3 for fastening purposes.

The gap-detecting unit 33 is used to detect the gap distance between the first and second magnetic bodies 30, 31, and to further output a magnetic force adjusting signal if the gap value is found to be inconsistent with a preset value, wherein the gap-detecting unit 33 is a gap sensor. In that the first and second magnetic bodies 30, 31 are disposed to remain in the same track, the gap-detecting unit 33 is preferably disposed on the same plane surface as the first and second magnetic bodies 30, 31 for easy detection of gap variations therebetween. Further, the preset value may vary according to actual requirements. For instance, the gap-detecting unit 33 may be fixedly disposed on the same side as the second magnetic body 31 on the vehicle body 36; that is, it is disposed opposite to the first magnetic body 30, and the preset value may be an initial gap value measured from the gap-detecting unit 33 to an initial position of the first magnetic body 30. Preferably, the gap-detecting unit 33 is powered through the vehicle for operation.

The electromagnetic control unit 34, which is electrically connected to the gap-detecting unit 33 and the power supply unit 38 respectively, is configured to receive a magnetic force adjusting signal output from the gap detecting unit 33, and further to control the magnetic intensity of either the first or second magnetic bodies 30, 31 by adjusting the adjustable electric current output from the power supply unit 38 according to the detected gap value for position adjustment of the first magnetic body 30, thereby adjusting the gap value therebetween to match the preset value. Preferably, the electromagnetic control unit 34 is powered through the vehicle for operation.

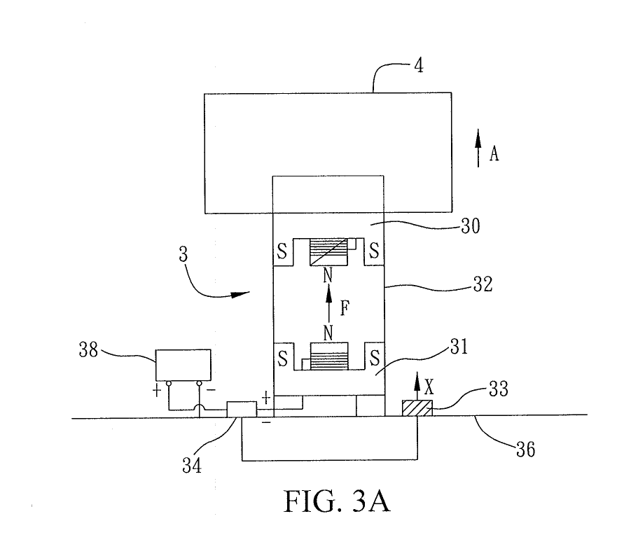

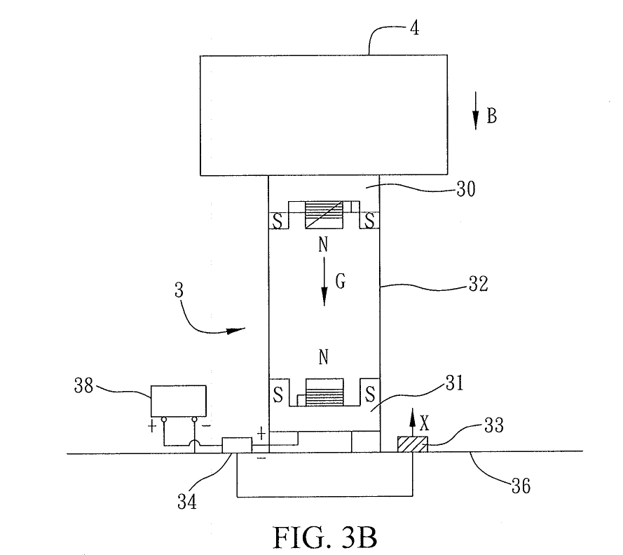

Referring to FIG. 3A in conjunction with FIG. 3B, a power supply unit 38 is optionally added to or built in the vehicle, and the electromagnetic control unit 34 may be, but is not limited to, an integrated circuit (IC). As illustrated in FIG. 3A, when the gap-detecting unit 33 detects a reduced gap value relative to the preset or initial value, the output current of the power supply unit 38 is adjusted to increase magnetic force for increasing the repulsive force F between the first and second magnetic bodies 30, 31, enabling the first magnetic body 30 to upward return to its original position shown in FIG. 2 in the direction indicated by the arrow A. Conversely, as illustrated in FIG. 3B, if the gap detecting unit 33 detects an expanded gap value, the output current of the power supply unit 38 is adjusted to decrease magnetic force for decreasing repulsive force F between the first and second magnetic bodies 30, 31, enabling the first magnetic body 30 to move downward to its original position shown in FIG. 2 by the gravitational force G of the communications/navigation device 4 in the direction indicated by the arrow B.

By the provision of the gap-detecting unit 33, which is continuously in the detection state, the first magnetic body 30 can be adjusted to move back for ultimately staying static at its initial position after certain times of upward and downward movements in case of a temporal deviation in position.

Note that it is only exemplary but not restrictive that first and second magnetic bodies 30, 31 are disposed in a vertical orientation as illustrated in this embodiment. The installation orientation may be adjusted, provided that the same effect is achieved.

### The Second Embodiment

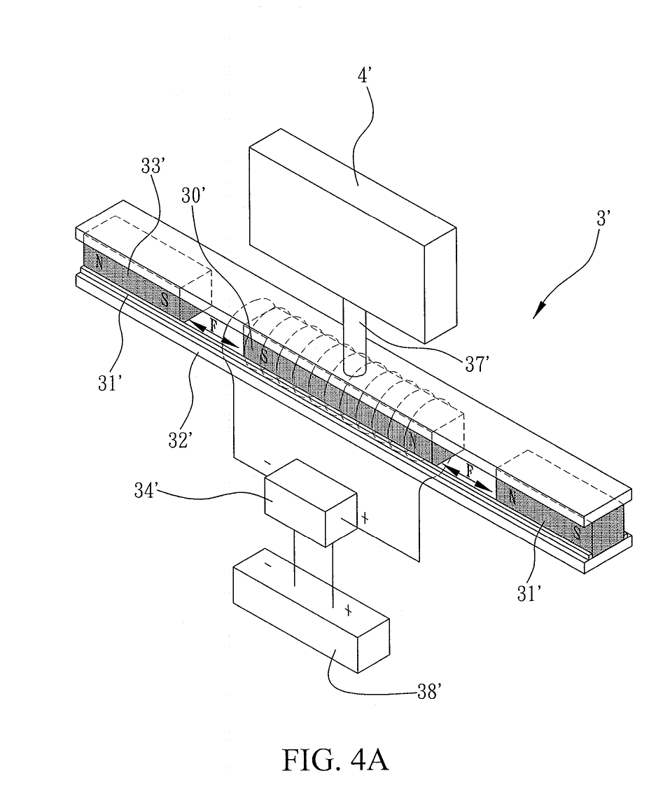

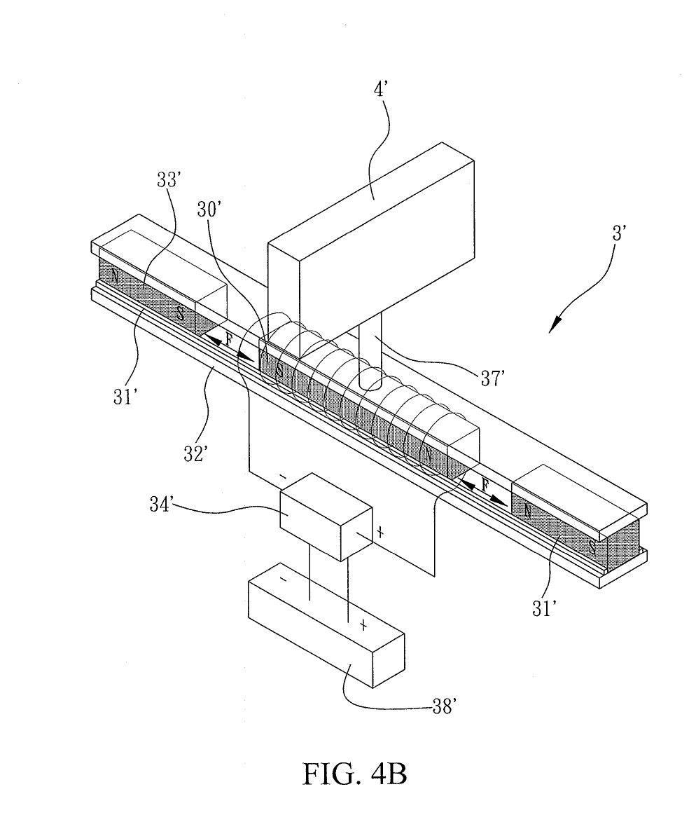

FIGS. 4A and 4B respectively depict two differing application examples of the vibration-proof holder 3′ applicable to a communications/navigation device used in a vehicle in accordance with the second embodiment of the present invention.

As described in the first embodiment, the vibration-proof holder 3 is installed to provide the communications/navigation device 4 with vibration-proof effect in a vertical direction. The second embodiment differs from the first embodiment only in that the second embodiment provides the communications/navigation device 4′ with vibration-proof effect in a horizontal direction.

As illustrated in FIG. 4A, the communications/navigation device 4′ is connected to the vibration-proof holder 3′ by coupling or affixing to an end of a connecting rod 37′, or by means of a fixed base, and another end of the connecting rod 37′ is fixedly connected to the first magnetic body 30′. The first magnetic body 30′ connects with the limiting member 32′ in a sliding manner and is controlled to move on/in the limiting member 32′ in two opposite directions only, wherein two second magnetic bodies 31′ are fixed to the limiting member 32′ on both sides of the first magnetic body 30′ respectively, facing the first magnetic body 30′ with the same polarity; that is, north pole to north pole and south pole to south pole.

In this embodiment, the limiting member 32′ may be fastened to the vehicle body 36′ by screws, welding or suction force. Similarly, the second magnetic bodies 31′ may also be fastened to the vehicle body 36′ by screws, welding or suction force, wherein, if the second magnetic bodies 31′ are previously fastened to the vehicle body 36′, the limiting member 32′ only needs to cover on the first magnetic body 30′ and the second magnetic bodies 31′ to achieve the same limiting result. The structures of the limiting member 32′ and means for fastening are well known to persons skilled in the art and may vary according to actual requirements, and the description of which being omitted herein for brevity.

Also, use of the connecting rod 37′ is optional in that the communications/navigation device 4′ can be directly fastened to, for example, affixed to or coupled to, the first magnetic body 30.

As described above, the gap-detecting unit 33′ may be disposed on one of the second magnetic bodies 31′ for detection of gap value therebetween, and when the detected gap value is found to be inconsistent with the preset value, the electromagnetic control unit 34′ proceeds to adjust the adjustable electric current output from the power supply unit 38′ to control the magnetic intensity of the first magnetic body 30′ to enable it to return to the initial position by the magnetic repulsive force. Similarly, the second magnetic body 31′ may be adjusted to achieve the same result if it is an electromagnet.

The communications/navigation device 4′ illustrated in FIG. 4A is disposed in parallel to the limiting member 32′, allowing the vibration-proof holder 3′ to counter vibration with respect to the communications/navigation device 4′ toward the left and the right. If the communications/navigation device 4′ is disposed in a manner of turning by 90 degrees or 180 degrees to be perpendicular to the limiting member 32′, the vibration-proof holder 3′ may counter vibration relative to the communications/navigation device 4′, forward and backward.

Further, there are two second magnetic bodies 31′ used in this embodiment and all the first and second magnetic bodies 30′, 31′ are rectangular bodies. In another embodiment, the first magnetic body 30′ may be of the shape of a cross, and four second magnetic bodies can be respectively disposed at the front, rear, left and right ends of the first magnetic body 30′, with the four first magnetic body 30′ being limited to face one another with the same polar end thereof, thereby achieving the effect of vibration-proof in four different directions on a plane.

Compared to prior techniques, the vibration-proof holder applicable to a communications/navigation device for use in vehicle of the present invention is characterized by employing a gap-detecting unit to detect position variations of the communications/navigation device, and an electromagnetic control unit to adjust the magnetic intensity of magnetic bodies installed in the vehicle, wherein first and second magnetic bodies are limited to remain in the same track and to face one another with same magnetic polar end thereof, such that the communications/navigation device can return to its initial position to achieve the vibration-proof effect. The present invention has a simple structure and can be produced at low costs and thus has high applicability.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A vibration-proof holder applicable to a communications/navigation device for use with a vehicle, the vibration-proof holder being connected to the communications/navigation device and the vehicle, the vibration-proof holder comprising:
a power supply unit for outputting an adjustable electric current;
a first magnetic body and a second magnetic body fixedly installed in the communications/navigation device and the vehicle respectively, at least one of the first and second magnetic bodies being an electromagnet and electrically connected to the power supply unit;
a limiting member fixedly installed in the vehicle to restrict the first and second magnetic bodies in a same track, allowing the first and second magnetic bodies to face one another with at least one same magnetic pole thereof;
a gap-detecting unit configured to detect a gap value between the first and second magnetic bodies and to further output a magnetic force adjusting signal if the detected gap value deviates from a preset value; and
an electromagnetic control unit configured to receive the magnetic force adjusting signal output from the gap-detecting unit and to control magnetic intensity of the first magnetic body and/or the second magnetic body by adjusting the adjustable electric current output from the power supply unit according to the detected gap value, thereby adjusting the gap value therebetween to be consistent with the preset value.

2. The vibration-proof holder as claimed in claim 1, wherein the first magnetic body is a permanent magnet and the second magnetic body is an electromagnet.

3. The vibration-proof holder as claimed in claim 1, wherein the first magnetic body is an electromagnet and the second magnetic body is a permanent magnet.

4. The vibration-proof holder as claimed in claim 1, wherein the first and second magnetic bodies are constituted by a permanent magnet and an electromagnet combined with one another.

5. The vibration-proof holder as claimed in claim 1, wherein the first and second magnetic bodies are disposed in a vertical orientation with respect to each other.

6. The vibration-proof holder as claimed in claim 1, wherein cross-sections of first and second magnetic bodies are of an “M” shape.

7. The vibration-proof holder as claimed in claim 1, wherein the gap-detecting unit is a gap sensor.

8. The vibration-proof holder as claimed in claim 1, wherein the communications/navigation device is a satellite navigation device.

9. The vibration-proof holder as claimed in claim 1, wherein the gap-detecting unit and/or the electromagnetic control unit are fixedly installed in the vehicle.

10. The vibration-proof holder as claimed in claim 1, wherein the power supply unit, the gap-detecting unit and/or the electromagnetic control unit are powered through the vehicle for operation.

11. A vibration-proof holder applicable to a communications/navigation device for use with a vehicle, the vibration-proof holder being connected to the communications/navigation device and the vehicle, the vibration-proof holder comprising:
a power supply unit for outputting an adjustable electric current;
a first magnetic body and a plurality of second magnetic bodies fixedly installed in the communications/navigation device and the vehicle respectively, at least one of the first and second magnetic bodies being an electromagnet and electrically connected to the power supply unit;
a limiting member fixedly installed in the vehicle to restrict the first and second magnetic bodies in a same track, allowing the first and second magnetic bodies to face one another with at least one same magnetic pole thereof;
a gap-detecting unit configured to detect a gap value between the first and second magnetic bodies and to further output a magnetic force adjusting signal if the detected gap value deviates from a preset value; and
an electromagnetic control unit configured to receive the magnetic force adjusting signal output from the gap-detecting unit and to control magnetic intensity of the first magnetic body and/or the second magnetic body by adjusting the adjustable electric current output from the power supply unit according to the detected gap value, thereby adjusting the gap value therebetween to be consistent with the preset value.

12. The vibration-proof holder as claimed in claim 11, wherein the first magnetic body is an electromagnet and the second magnetic body is a permanent magnet.

13. The vibration-proof holder as claimed in claim 11, wherein the first magnetic body is a permanent magnet and the second magnetic body is an electromagnet.

14. The vibration-proof holder as claimed in claim 11, wherein the first and second magnetic bodies are constituted by a permanent magnet and an electromagnet combined with one another.

15. The vibration-proof holder as claimed in claim 11, wherein the first and second magnetic bodies are disposed in a horizontal direction with respect to each other.

16. The vibration-proof holder as claimed in claim 11, wherein the first and second magnetic bodies are of a rectangular shape.

17. The vibration-proof holder as claimed in claim 11, wherein the gap-detecting unit is a gap sensor.

18. The vibration-proof holder as claimed in claim 11, wherein the communications/navigation device is a satellite navigation device.

19. The vibration-proof holder as claimed in claim 11, wherein the gap-detecting unit and/or the electromagnetic control unit are fixedly installed in the vehicle.

20. The vibration-proof holder as claimed in claim 11, wherein the power supply unit, the gap-detecting unit and/or the electromagnetic control unit are powered through the vehicle for operation.
